(19) United States
(12) Patent Application Publication
(10) Pub. No.: US 2011/0199192 A1
(43) Pub. Date: Aug. 18, 2011

(54) RECONFIGURATION OF A RADIO FREQUENCY TAG

(76) Inventor: Mark Alan Buckner, Oak Ridge, TN (US)

(21) Appl. No.: 12/705,131

(22) Filed: Feb. 12, 2010

(51) Int. Cl. H04Q 5/22

(52) U.S. Cl. 340/10.51; 340/10.1

(57) ABSTRACT

A method for configuring a radio frequency (RF) tag is provided. The method comprises determining communication characteristics for a first RF device coupled with the RF tag, and configuring the RF tag as a function of the communication characteristics for the first RF device. The first RF device uses the communication characteristics to communicate with the RF tag. The communication characteristics define a first operating frequency and a first protocol. The RF tag is configured as a function of the communication characteristics for the first RF device, such that the RF tag is operable to communicate with the first RF device at the first operating frequency and using the first protocol.

### FEDERALLY SPONSORED RESEARCH OR DEVELOPMENT

This invention was made with government support under Contract No. DE-AC05-00OR22725 awarded by the U.S. Department of Energy. The government has certain rights in the invention.

### BACKGROUND

A radio frequency (RF) tag communicates with a RF device, such as a RF reader, other RF tag, or RF radio. Communication includes transmitting and/or receiving an RF signal. The RF tag is configured to communicate using defined communication characteristics, such as a defined frequency, a defined wavelength, and/or one or more defined protocols. The RF tag is operable to communicate with a RF device that is configured to communicate using the same communication characteristics as the RF tag. However, the RF tag is unable to communicate with an RF device, which is not configured to communicate using the RF tag's communication characteristics. For example, in the United States, a RF reader is configured to communicate at 433 or 915 megahertz (MHz). In Europe; however, a RF reader is configured to communicate at 868 MHz. A RF tag, which is configured to communicate with the RF reader in the United States, is unable to communicate with the European RF reader since the RF tag does not communicate at the same frequency as the European RF reader.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates one embodiment of a radio frequency (RF) system.

FIG. 2 illustrates one embodiment of a configurable RF tag.

FIG. 3 illustrates one example of communication characteristics.

FIG. 4 illustrates another example of communication characteristics.

FIG. 5 illustrates another example of communication characteristics.

FIG. 6 illustrates another embodiment of a configurable RF tag.

FIG. 7 illustrates yet another embodiment of a configurable RF tag.

FIG. 8 illustrates one embodiment of a method for configuring an RF tag.

FIG. 9 illustrates one embodiment of a method for receiving context information.

### DETAILED DESCRIPTION

A radio frequency (RF) tag may be configured or reconfigured to communicate with one or more RF devices. The RF devices use the same or different communication characteristics as each other or the RF tag. Herein, “configured” and “reconfigured” relate to the adjustment of hardware, software, firmware, documentation, or any combination thereof that performs a specific act, such as communicating at a defined RF or using a defined protocol. Herein, “communication characteristics” include or define zero, one, or more of the following: a signal property (e.g., frequency, wavelength), a communication standard (e.g., protocols, a stack of protocols), a RF device requirement (e.g., the location of a RF reader with respect to a RF tag), an authentication requirement (e.g., password, encryption), a geographical requirement (e.g., environment-specific requirement, location-specific requirements), a user-defined requirement (e.g., user-defined rules), any combination thereof, or any now known or later developed characteristic relating to communicating an RF signal. For example, configuration and/or reconfiguration may include reader/gateway functions, modulation, shaping, error-correction coding, and symbol encoding. The communication characteristics define the requirements for communicating with a device, such as the RF tag 20 or RF device 30.

By way of introduction, the embodiments described below include systems and methods for configuring an RF tag. In one method, a RF tag receives a first RF signal from a first RF device. The RF tag determines the first RF device's communication characteristics. The RF tag is configured to communicate using the determined communication characteristics. Accordingly, the RF tag and the first RF device are operable to communicate using the determined communication characteristics. The RF tag may determine a second RF device's communication characteristics. The second RF device's communication characteristics may be the same or different from the first RF device's communication characteristics. The RF tag may switch between configurations, such that the RF tag is configured to communicate with multiple RF devices having the same or different communication characteristics. One benefit of such a method is that the RF tag is operable to communicate with an increased number of RF devices. The RF tag is not limited to communicating with RF devices that use the set of communication characteristics that the RF tag is presently configured to use for communication.

In one system, an RF Tag includes a memory and a processor. The processor is coupled to the memory, such that the processor is operable to execute instructions stored on the memory. The memory stores data representing instructions. The instructions may include sensing instructions that are executed by the processor to cause a sensor to sense a system attribute; determine instructions that are executed by the processor to determine a first device's communication characteristics; configure instructions that are executed by processor to configure the RF tag, such that the RF tag is operable to communicate with the first device; and communicate instructions that are executed by the processor to communicate the system attribute to the first device using the first device's communication characteristics.

In another system, an RF tag is coupled with a mobile (moveable) object and an RF device. The RF tag is operable to transmit an RF signal to or receive an RF signal from the RF device. The RF tag determines communication characteristics used to communicate with the RF device. The RF tag is configured to communicate using the determined communication characteristics. However, a second RF device's communication characteristics may be determined. The RF tag may be configured to communicate using the second RF device's communication characteristics. Accordingly, the RF tag may provide information relating to the mobile object to multiple RF devices, which do or do not have the same communication characteristics.

In one illustration, which is referred to herein as “the above illustration,” a configurable RF tag according to the disclosed embodiments is placed in or on a chemical container. The chemical container is shipped from Chicago to Germany. A truck is used to carry the chemical container from Chicago to New York City. A cargo-ship transports the chemical container from New York City to France. A train delivers the chemical container from France to Germany. The configurable RF tag may use a sensor to sense container information, such as pressure information, chemical levels, and leakage information. Alternatively, or in addition thereto, the configurable RF tag be preprogrammed with container information, such as information or a unique identifier describing the container contents, shipping entity, destination entity, etc. The container information is communicated to one or more RF readers during the shipment. For example, a first RF reader may be disposed above or along the side of a highway on which the truck traverses, such as a highway in Indiana. The first RF reader may be part of a toll system, such as EasyPass or I-Pass. The first RF reader may relay the container information to a personal computer. The local authorities (e.g., the Indiana State Police) use the personal computer to monitor the chemical levels in the chemical container. The first RF reader communicates with the configurable RF tag at 433 MHz and using an encryption protocol. In another example, a second RF reader may be disposed along a railroad track in France. The second RF reader may relay the container information to a monitoring system in Paris. The local authorities, such as the French National Guard, may use the monitoring system to check the chemical levels in the chemical container. The second RF reader communicates with the RF tag at 868 MHz and using an authentication protocol. The configurable RF tag is operable to be configured to communicate with the first RF reader (which communicates at 433 MHz and using an encryption protocol) and the second RF reader (which communicates at 868 MHz and using an authentication protocol). In another embodiment, the first and second RF readers may communicate using the ISO 18000-7 & ANSI/INCITS 256 standards, which use the same frequency (e.g., 433 MHz). In another example, the first and second RF readers may communicate using the ISO 18000-4 & ISO 18000-7 standards, which use different frequencies (e.g., 2.45 GHz/433 MHz)

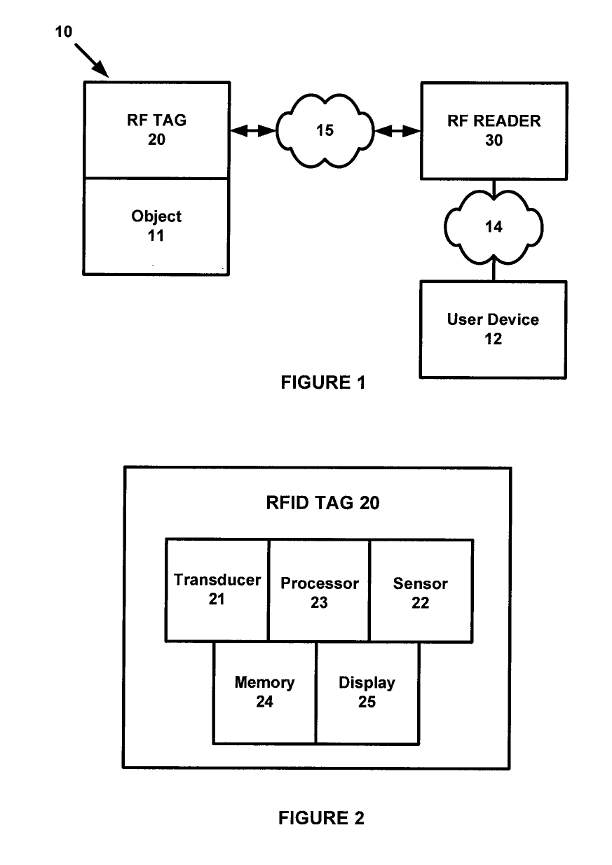

FIG. 1 shows one embodiment of a system 10 for RF communication. The system 10 includes an object 11, a user device 12, an RF tag 20, and an RF device 30. The object may be a moveable object, stationary object, or mobile object. The object 11 is coupled with the RF tag 20. The RF tag 20 is permanently or periodically coupled with the RF device 30 through the network 15. The RF device 30 is coupled with the user device 12 through the network 14. Herein, the phrase “coupled with” is defined to mean directly connected to or indirectly connected through one or more intermediate components. Such intermediate components may include both hardware and software based components. In alternative embodiments, additional, different, or fewer components may be provided.

The system 10 is a communication system, a RF identification (RFID) system, supply-chain system, security system, a configuration system, a detection system, a relay system, or any combination thereof. The system 10 provides automated assistance for determining one or more system attributes, such as an object 11 attribute (e.g., pressure, force, chemical levels), a RF tag 20 attribute (e.g., RFID, temperature, power, location), a RF device 30 attribute (e.g., location, distance from the RF tag 20), an environment attribute (e.g., elevation, weather conditions), any combination thereof, or other system-related attribute. The system 10 automatically configures the RF tag 20 to communicate with the RF device 30. The RT tag 20 is configured as a function of one or more RF device communication characteristics. The RF tag 20 automatically communicates the system attributes to the RF device 30, which communicates the system attributes to the user device 12. A system user, such as someone interested in the one or more system attributes, may use the user device 12 to view the system attributes.

The object 11 is a moveable (mobile) or immovable object. For example, the object 11 is a good, a human, an animal, a container, a product, a traceable object, or other object that may be coupled with the RF tag 20. As shown in FIG. 1, the RF tag 20 may be fixed or attached to interior or exterior of the object 11 or otherwise integrated therewith. In the illustration above, the chemical container is the object 11. The RF tag is fixed to the inside of the chemical container. In alternative embodiments, the RF tag 20 is placed adjacent to, inside of, outside of, on top of, underneath of, or around the object 11.

The networks 14, 15 are communication networks, RF networks, Internet Protocol (IP)/Transfer Control Protocol (TCP) networks, cellular networks, satellite communication networks, wireless networks, wired networks, or other now known or later developed network, or combination thereof, for providing communication. For example, the network 15 includes an RF network, and the network 14 includes an IP/TCP network. The networks 14, 15 are used to transmit and receive information, such as signals or messages. The signals or messages may be data, biometrics, or telematics. The networks 14, 15 may be defined networks, such as protocol defined networks.

FIG. 2 shows one embodiment of a RF tag 20. The RF tag 20 includes a transducer 21, a sensor 22, a processor 23, a memory 24, and a display 25. The processor 23 is coupled with and operable to communicate with the other components. In alternative embodiments, additional, different, or fewer components may be provided. For example, an internal power supply source may be provided.

The RF tag 20 is a passive RF tag, an active RF tag, a semi-passive RF tag, or any now known or later developed RF tag. A passive RF tag may operate without receiving power (or, at least very little power) from an internal or external power supply source. During operation, an incoming RF signal induces electrical current in the transducer 24, which is discussed in greater detail below. The electrical current provides power for an integrated circuit, which powers up the RF tag 20. The passive RF tag may use backscattering for communication with the RF device 30. For example, the transducer 24 collects power from the incoming signal, which induces electrical current, and transmits the outbound backscatter signal using the collected power. The outbound backscatter signal may be a RF signal, which may include an ID number, context information, or other information stored in memory 22.

An active RF tag receives power from a power supply source, such as a battery or energy store. The power supply source is used to broadcast a response signal to the RF device 30. The power supply source allows an active RF tag 30 to transmit RF signals to the RF reader 20 at higher power levels than passive tags. The RF tags 20 may operate in “RF challenged” environments, such as humidity, spray, dampening targets (e.g., humans/cattle, which contain mostly water), reflective targets from metal (e.g., shipping containers, vehicles), or at longer distances. The RF signals may include an ID number, context information, or other information stored in memory 22.

A semi-passive RF tag does not use a power supply source to broadcast a response signal. The response signal is powered by backscattering the RF energy from the reader, where energy is reflected back to the RF reader. In one embodiment, the power supply source may power the memory 22. The RF signal of a semi-passive RF tag may include an ID number, context information, or other information stored in memory 22.

The transducer 21 is an electromagnetic transducer (e.g., antenna), an electrochemical transducer (e.g., pH probe), an electromechanical transducer (e.g., strain gauge), electroacoustic transducer (e.g., hydrophone, loudspeaker, microphone, geophone), photoelectric transducer (e.g., laser diode, light-emitting diode, photodiode), electrostatic transducer (e.g., electrometer), thermoelectric transducer (e.g., thermocouple, peltier cooler, thermistor), radioacoustic transducer (e.g., Geiger-Muller tube, radio receiver), radiation transducer, light sensor, passive infrared, or any other now known or later developed transducer.

The transducer 21 converts one type of energy or physical attribute to another. For example, a laser diode converts electrical power into forms of light. In another example, a strain gauge converts a force into an electrical signal. In the illustration above, the configurable RF tag, which was placed in the chemical container, includes an antenna as the transducer 21. The antenna is operable to convert electromagnetic waves, such as waves operating in the RF range, into electric current. Furthermore, the antenna may convert electric current into electromagnetic waves.

In one embodiment, the transducer 21 receives RF signals from and transmits RF signals to the RF device 30. An RF signal may be a request signal (e.g., requesting an RFID or a system 10 attribute), a response signal (e.g., providing an RFID or a system 10 attribute in response to a request signal), or an informative signal (e.g., providing an RFID or a system 10 attribute). In the illustration above, during transportation from Chicago to NYC, the first RF reader transmits an RF request signal to the RF tag. The request signal includes a request for an RFID and a chemical level. The RF tag uses the antenna to transmit a response signal, which includes an RFID, which identifies the RF tag, and the current chemical level in the chemical container. Alternatively, an informative signal may be transmitted in response to, or independently of, the request signal.

As used herein, “transducer information” relates to information received or transmitted using the transducer 21. For example, the transducer 21 may detect an in-coming RF signal. The in-coming RF signal may be used as transducer information.

In one embodiment, the transducer 21 is configurable to communicate using the RF device's communication characteristics. Configuration may be, at least in part, implemented using hardware. For example, the processor 21 may adjust the length of an antenna to communicate using one or more radio frequencies. The length may be the effective electric length or physical length. In an alternative embodiment, the transducer 21 includes fixed and static hardware.

The transducer 21 operates with or without instruction from the processor 23 or other processing unit. For example, in-coming signals induce electrical current in the transducer 21. The electrical current may be used to power-on the processor or other processing unit. In another example, the processor 23 may periodically instruct the transducer to detect in-coming signals at a defined time or location, such as once a minute, twice an hour, or three times in each state.

The sensor 22 is a smart sensor, thermal sensor, electromagnetic sensor, mechanical sensor, pressure sensor, location sensor, chemical sensor, optical radiation sensor, acoustic sensor, ionizing radiation sensor, transducer (as discussed above), communication device, a sensor based on Micro-Electro-Mechanical Systems (MEMS), nano-science sensor, nano-bio-electrical material sensor, or other now known or later developed sensor.

The sensor 22 is a device that senses or detects a system attribute. Sensing may include measuring, detecting, or identifying. The system attribute may be a quality, a characteristic, a location, a physical property, or communication. For example, the sensor 22 may measure temperature, humidity, pressure, velocity, acceleration, location, shock, chemical levels, biological levels, radiological levels, nuclear levels. In another example, the sensor 22 detects video, audio, ultrasound, or light (e.g., infrared or near-infrared). In yet another example, the sensor 22 is a location sensor, such as a Global Positioning System (GPS) receiver, that is used to locate the position of the RF tag 20.

In one embodiment, the sensor 22 is a communication device that is operable to communicate using a communication network, such as a cellular network, United States Department of Defense network, a logistics network, a WiFi network (e.g., 802.x), a home network, a wide area network, a Worldwide Interoperability for Microwave Access (WiMAX) network, a 2-way paging network, satellite network (e.g., using an Iridium Satellite LLC product), GPS waveform network, or other now known or later developed network. The communication device may be used to receive information, such as updates (e.g., new protocols, updates to protocols), instructions (e.g., over-the-air programming instructions), messages, or other communication from one or more external communication device. The received information may be used to update the RF tag. For example, the received information may be used to update a device's communication characteristics, which may be stored in memory 24. In another example, the received information may be used to update configuration settings or instructions.

As used herein, “sensor information” relates to information received or transmitted using the sensor 22. For example, the sensor information may include one or more system attributes.

FIG. 2 shows a RF tag 20 with a single transducer 21 and a single sensor 22. However, the RF tag 20 may include and/or communicate with one or more transducers 21 and/or one or more sensors 22. For example, in one embodiment, the RF tag 20 includes a thermal sensor and a communication device. In the illustration above, the RF tag 20 includes a chemical sensor, which measures a chemical level in the chemical container, and a communication device that receives updated protocols (e.g., for the European RF reader).

The processor 21 is a general processor, a hybrid programmable processor, a digital signal processor, application specific integrated circuit, multi-core such as Coherant Logix' HyperX, field programmable gate array, analog circuit, digital circuit, combinations thereof, or other now known or later developed processor. The processor 21 may be a single device or a combination of devices, such as associated with a network or distributed processing. Any of various processing strategies may be used, such as multi-processing, multi-tasking, parallel processing, remote processing or the like. The processor 21 is responsive to instructions stored as part of software, hardware, integrated circuits, firmware, micro-code or the like. For example, the processor 21 is operable to execute instructions stored in memory 22.

For more detailed information regarding a hybrid programmable processor, please refer to U.S. Pat. No. ______, entitled “HYBRID PROGRAMMABLE PROCESSOR,” which was filed on ______ and which is hereby incorporated by reference.

The processor 23 is operable to communicate with and control the transducer 21, sensor 22, the memory 24, the display 25, or any combination thereof. Communication may include transmitting or receiving signals. The signals may be transmitted across a network, such as a wire, a circuit, a wireless network, or any other communication network. For example, the processor 23 is operable to request sensor information from the sensor 22 and instruct the transducer 21 to transmit the sensor information to the RF device 30. In another example, the processor 23 is operable to read from or write to the memory 24.

As discussed above, communication characteristics may include zero, one, or more of the following: a signal property (e.g., frequency, wavelength), a communication standard (e.g., protocols, a stack of protocols), a RF device requirement (e.g., the location of a RF reader with respect to a RF tag), an authentication requirement (e.g., password, encryption), a geographical requirement (e.g., environment-specific requirement, location-specific requirements), a user-defined requirement (e.g., user-defined rules), any combination thereof, or any now known or later developed characteristic relating to communicating an RF signal.

Table 1 illustrates exemplary communication standards.

TABLE 1
Communication Characteristics

| Description | Communication Standards |
|---|---|
| Parameters for air interface | ISO/IEC 18000-3:2008 |
| communications below 135 kHz | |
| Radio frequency identification for | ISO/IEC 18000-1:2008 |
| item management | |
| Radio frequency identification for | ISO/IEC 18000-2:2004 |
| item management | |
| Parameters for air interface | ISO/IEC 18000-4:2008 |
| communications at 13.56 MHz | |
| Parameters for air interface | ISO/IEC 18000-6:2004 |
| communications at 2.45 GHz | |
| Parameters for air interface | ISO/IEC 18000-7:2008 |
| communications at 860 MHz to 960 MHz | |
| Parameters for active air interface | ISO/TS 10891:2009 |
| communications at 433 MHz | |
| Freight | (1) EPCGlobal UHF Class 1 |
| Containers and | Gen 2 (860-930 MHz); |
| License Plate Standards | (2) HF Gen 2 (13.56 MHz); |
| | 802.11 (header based); |
| | (3) Ultra-wideband; |
| | (4) ZigBee (802.15.4) |

Communication characteristics are associated with one or more RF devices. The communication characteristics for a first RF device may be the same or different than the communication characteristics for a second RF device. In the illustration above, the RF reader disposed above the highway in Indiana is associated communication characteristics that define the RF reader's operating frequency (e.g., 433 MHz) and communication protocol (e.g., an encryption protocol). The RF reader disposed alongside the railroad track in Europe is associated communication characteristics that define the RF reader's operating frequency (e.g., 868 MHz) and communication protocol (e.g., an authentication protocol).

The processor 23 is operable to determine the RF device's 30 communication characteristics. Determining the communication characteristics may include signal processing, reading from memory (e.g., database), or other act, method, or process for recognizing or identifying communication characteristics. The processor 23 may determine the RF device's 30 communication characteristics as a function of sensor information, transducer information, time, location, an event, a trigger, a combination thereof, or other stimuli for determining communication characteristics. As used herein, “as a function” may be interrupted to mean “using,” “directly depending upon,” “indirectly depending upon,” “utilizing,” or “based upon.”

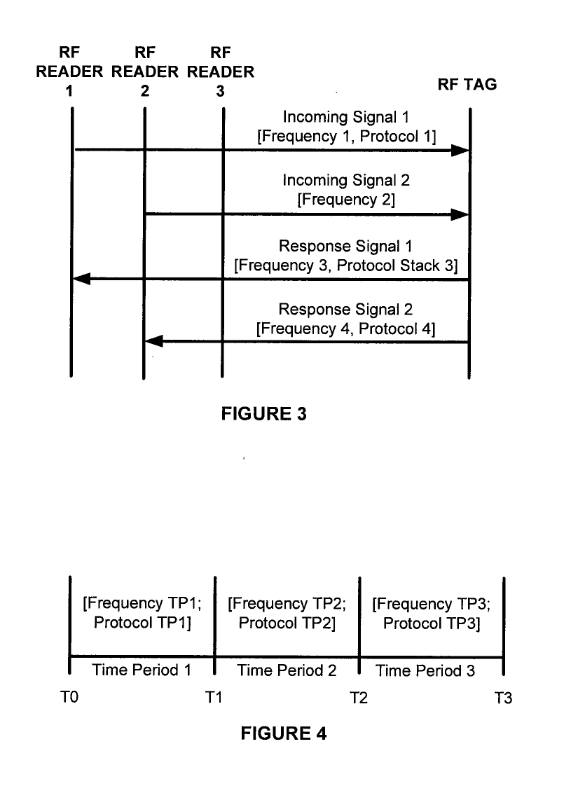

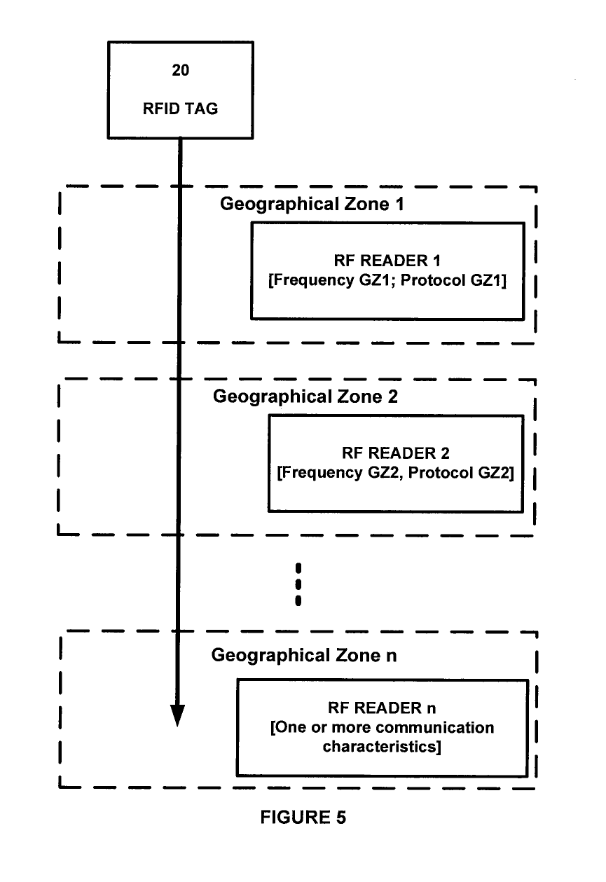

FIGS. 3-5 show examples of determining communication characteristics. More specifically, FIG. 3 illustrates an example of determining communication characteristics as a function of transducer information. FIGS. 4-5 illustrate examples of determining communication characteristics as a function of sensor information.

In the example of FIG. 3, the RF TAG receives one or more incoming signals (e.g., Incoming Signal 1, Incoming Signal 2, Incoming Signal 3) from one or more RF readers (e.g., RF READER 1, RF READER 2, RF READER 3). The Incoming Signal 1 is processed to determine RF Reader 1's communication characteristics. Accordingly, the RF TAG determines that RF READER 1 is communicating at Frequency 1 and using Protocol 1. In this example, Frequency 1 and Protocol 1 are the communication characteristics used to communicate with RF Reader 1. The RF Tag may determine RF Reader 2's communication characteristics and RF Reader 3's communication characteristics.

One benefit of determining communication characteristics as a function of an incoming signal is that the RF Tag 20 may dynamically communicate with one or more RF readers, which use the same or different communication characteristics, using only the communication between the RF Tag 20 and the RF Device 30. As used herein, “dynamically” relates to switching, changing, altering, or adjusting, one or more aspects of a configuration. In this example, configuring the RF tag may not depend on location or other factors.

In the example of FIG. 4, communication characteristics are determined as a function of time. The RF Tag has a sensor 22, such as a timer, that determines the current time. The RF Tag determines whether the current time is in Time Period 1 (T0-T1), Time Period 2 (T1-T2), and/or Time Period 3 (T2-T3). As used herein, a “time period” is the period of time beginning at one time (e.g., T0) and ending at another time (e.g., T1). One or more time periods may be stored in a database (e.g., in the memory 24) and associated with communication characteristics. As shown in FIG. 4, Time Period 1 is associated with operating Frequency TP1 and Protocol TP1. Accordingly, Frequency TP1 and Protocol TP1 are used for communication during Time Period 1 (T0-T1). Alternatively, a past time or time period (e.g., a departure time, previous time period) or a future time or time period (e.g., estimated time of arrival, estimated length of a trip) may be used.

In alternative embodiments, time zones, travel time, speed, sensor levels that depend on time, and other time related values may be used to determine communication characteristics. By way of example, when a detected level is above a threshold level for a predefined time period, the processor 23 may begin communicating using emergency communication characteristics, for example, at an emergency frequency.

In the example of FIG. 5, the processor 23 determines the communication characteristics as a function of location of the RF tag 20. In this example, the RF Tag includes a sensor 22, such as a GPS device, that determines the current location of the RF Tag 20. The processor 23 determines whether the current location is in Geographical Zone 1 and/or Geographical Zone 2. The Geographical Zones are associated with communication characteristics for one or more RF readers. Accordingly, if the RF tag 20 is in Geographical Zone 1, then the RF Tag 20 determines that the RF Reader 1's communication characteristics include Frequency GZ1 and Protocol GZ2. If the RF tag 20 is in Geographical Zone 2, then the RF tag 20 determines that the RF Reader 2's communication characteristics include Frequency GZ2 and Protocol GZ2. Alternatively, past or future locations may be used. For example, the next destination of a trip may be used.

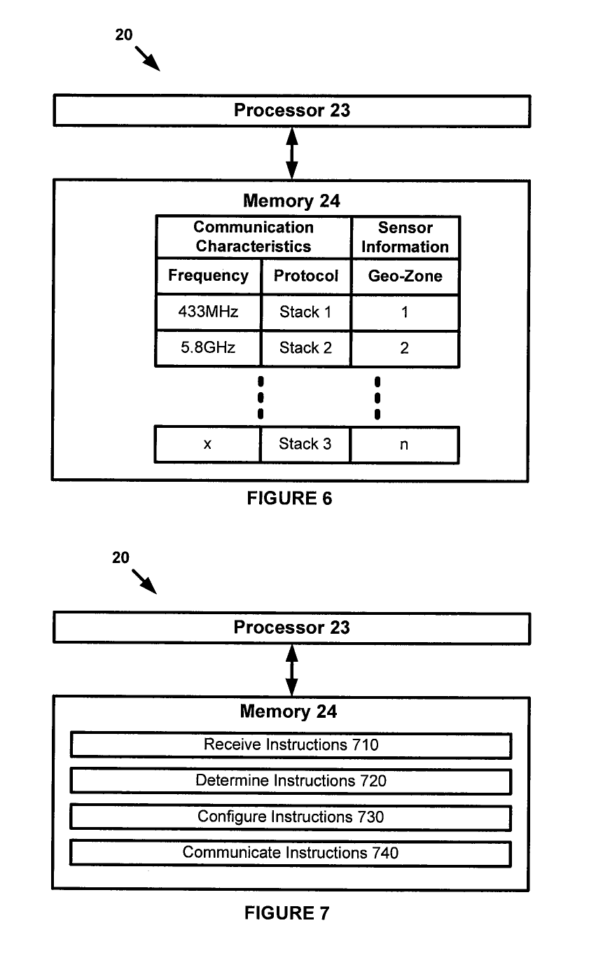

FIG. 6 illustrates one example of the associations connecting the communication characteristics and Geographical Zones, which are shown in FIG. 5. The associations may be stored in a database in the memory 24. The processor 23 may read the memory 24 to determine the associations. As shown in FIG. 6, in the memory 24, Geographical Zone 1 is associated with an operating frequency at 433 MHz and a protocol stack 1. As used herein, a “protocol stack” is a combination of zero, one, or more protocols. The protocols may be used together to provide standardized communication.

In alternative embodiments, location markers, the landscape, the weather, signs, or environment characteristics may be used to determine one or more communication characteristics. For example, a first frequency may be used when it is raining, and a second frequency may be used when it is snowing. The first frequency and the second frequency may be the same or different. In another example, a first protocol stack may be used when the RF tag is above a certain elevation, and a second protocol stack may be used when the RF tag is below the certain elevation.

The RF tag 20 may continuously or periodically determine communication characteristics. Accordingly, the RF tag 20 may detect a change in communication characteristics. For example, as shown in FIG. 3, the RF tag 20 may detect a change from RF Reader 1's communication characteristics (e.g., [Frequency 1, Protocol 1]) to RF Reader 2's communication characteristics (e.g., [Frequency 2, Protocol]). In another example, as shown in FIG. 4, the RF tag 20 detects when the current time transitions from Time Period 1 to Time Period 2. In yet another example, as shown in FIG. 5, the RF tag 20 detects when the RF tag 20 transitions from Geographical Zone 1 to Geographical Zone 2.

The processor 23 may configure the RF tag 20 to communicate using the RF device 30's communication characteristics. Configuring the RF tag 20 may include the adjustment of hardware, software, firmware, documentation, or any combination thereof. For example, analog and/or digital circuits may be configured or reconfigured to communicate using the determined communication characteristics. In another example, software is configured to switch one portion of the communication characteristics (e.g., protocol), and hardware (e.g., an antenna) is configured to switch another portion of the communication characteristics (e.g., frequency).

The processor 23 may determine an efficient configuration for configuring the RF Tag 20. As used herein, “an efficient configuration” is a configuration of hardware and software that maximizes one or more of the RF tag's 20 resources, such as power. For example, the hardware and/or software components of the RF tag 20, which are used to communicate using the determined communication characteristics, are powered up; whereas, the non-needed components are powered down or turned off. The efficient configuration may be used to configure the RF tag 20. In one embodiment, the efficient configuration may be received from an external communication device.

The processor 23 may cause an RF signal to be transmitted to the RF device 30. The RF signal may be transmitted using the determined communication characteristics for the RF device 30. For example, as shown in FIG. 3, the RF TAG may transmit Response Signal 1 to RF Reader 1 and transmit Response Signal 2 to RF Reader 2. Response Signal 1 may be transmitted at Frequency 1 and using Protocol 1. Response Signal 2 may be transmitted at Frequency 2 and using Protocol 2. Frequency 1 may be the same or different than Frequency 2, and Protocol 1 may be the same or different than Protocol 2. In the illustration above, the RF tag while in Indiana transmits an RF signal, which includes a chemical level in the chemical container, to the first RF reader at 433 MHz and using an encryption protocol. However, while in France, the RF tag transmits an RF signal, which includes a chemical level in the chemical container, to the second RF reader at 868 MHz and using an authentication protocol.

The processor 23 is operable to authenticate communication with the RF tag or RF tag configuration. Authentication may include verifying, confirming, or checking security. The processor 23 may authenticate any communication received or identified by the RF tag. The processor 23 may also authenticate a configuration. As an example of authentication, the processor 23 is operable to authenticate an RF device (e.g., using login identification, password, codes, keys), software (e.g., waveforms, protocols, bitfiles, firmware, algorithms, applications, device drivers), hardware (e.g., sensors, actuators, antennas), configuration of internal circuits (e.g., analog, digital), interconnects and devices, modules, peripherals within the RF tag.

The processor 23 communicates with memory 24. Communication may include reading, writing, storing, retrieving, requesting, or a combination thereof. For example, the processor 23 may store sensor information, transducer information, or signal requirements in the memory 24. The processor 23 may retrieve the stored information. The retrieved information may be used, for example, to determine communication characteristics.

The processor 23 may cause information to be displayed on the display 25. For example, the processor 23 may cause sensor information, transducer information, signal requirements, messages, or any other information to be displayed on the display 25.

The memory 24 is computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 24 may be a single device or a combination of devices. The memory 24 may be adjacent to, part of, networked with and/or remote from the processor 23.

The memory 24 may store information. For example, the memory 24 may store sensor information, transducer information, communication characteristics, associations, or communication requirements. The memory 24 may provide the stored information to the processor 23. For example, the information may be read from the memory 24.

The memory 24 may store data representing instructions executable by a programmed processor, such as processor 23. The processor 23 is programmed with and executes the instructions. The functions, processes, acts, methods or tasks illustrated in the figures or described herein are performed by the programmed processor 23 executing the instructions stored in the memory 24. The functions, acts, processes, methods or tasks are independent of the particular type of instructions set, storage media, processor, or processing strategy and may be performed by software, hardware, integrated circuits, firm ware, micro-code and the like, operating alone or in combination.

FIG. 7 shows one embodiment of an RF Tag 20 with a programmed processor 23 and memory 24 storing data representing instructions, which are executable by the processor 23. As shown in FIG. 7, the memory 24 includes receive instructions 710, determine instructions 720, configure instructions 730, and communicate instructions 740. In alternative embodiments, additional, different, or fewer instructions may be provided in other embodiments.

As shown in FIG. 7, the receive instructions 710 are executed to actively or passively receive transducer information and/or sensor information. The determine instructions 720 are executed to determine one or more communication characteristic or one or more sets of communication characteristics for one or more RF readers 30. The one or more communication characteristics may be determined as a function of the transducer information or sensor information. The configure instructions 730 are executed to configure the RF tag 20, such that the RF tag 20 is operable to communicate with an RF device 30, which is communicating using one or more of the determined communication characteristics. Configuration may include configuring hardware, software, or the combination thereof. The configuration may be a complete configuration or a partial configuration. The communicate instructions 740 may be executed to communicate with an RF device 30, which is using the one or more communication characteristics. The communicate instructions 740 may be executed to transmit and receive RF signals. Since the RF tag is configured to communicate RF signals with the communication characteristics, the RF device 30 receive RF signals in compliance with the communication characteristics used by the RF device 30.

The display 25 is a hybrid programmable display device, a cathode ray tube, monitor, flat panel, a general display, liquid crystal display, projector, printer or other now known or later developed display device for outputting information. The display 25 displays information and/or one or more images. For example, the display 25 displays sensor information, transducer information, communication characteristics, or any other information. In another example, the display 25 displays images related to sensor information, transducer information, communication characteristics, or any other information.

For more detailed information regarding a hybrid programmable display device, please refer to U.S. Pat. No. ______, entitled “HYBRID PROGRAMMABLE DISPLAY DEVICE,” which was filed on ______ and which is hereby incorporated by reference.

The RF device 30 is a RF reader, another RF tag, RF radio, or other RF communication device. The RF device is operable to communicate with the RF tag 20 using the network 15. The RF device 30 may receive an RF signal from the RF tag 20. The RF device 20 may transmit the RF signal to the user device 12. The user device 12 may be used to display or store information, such as a system 10 attribute communicated in the RF signal.

The user device 12 is a communication device, personal computer, server, remote memory store, personal digital assistant, cellular device, or any other device for communicating with the RF device 30. In one embodiment, RF device 30 includes the user device 12. A user may use the user device 12 to view or control communication received from or transmitted to the RF device 30. In the illustration above, the personal computer is the user device 12. The personal computer displays the chemical levels in the

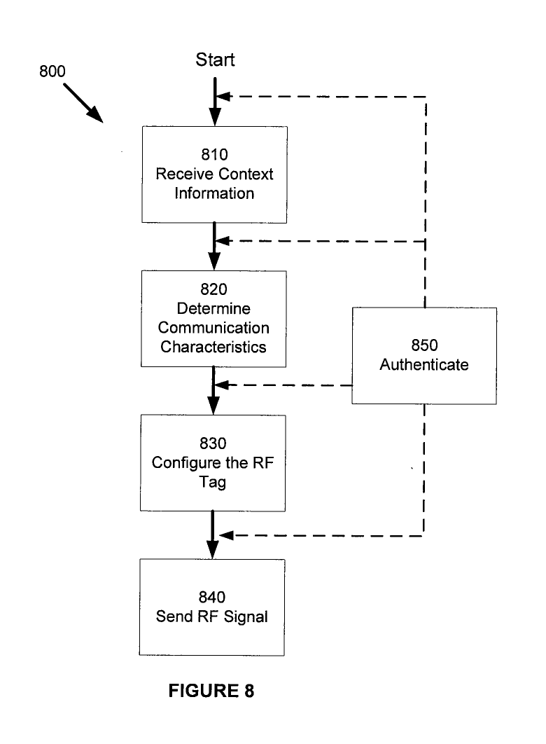

FIG. 8 shows a method 800 for configuring an RF Tag. The method 800 is implemented using the system 10 of FIG. 1 or a different system. The acts may be performed in the order shown or a different order. For example, act 850 may be performed before or after act 810, act 820, act 830, or act 840. The acts may be performed automatically, manually, or the combination thereof.

The method 800 may include receiving context information [act 810]; determining communication characteristics for one or more RF devices [act 820]; configuring the RF tag [act 830]; and sending an RF signal [act 840]. In alternative embodiments, additional, different, or fewer acts may be provided. For example, act 810 and act 850 do not need to be performed. In another example, the method 800 may include displaying and/or storing sensor information, transducer information, or communication characteristics.

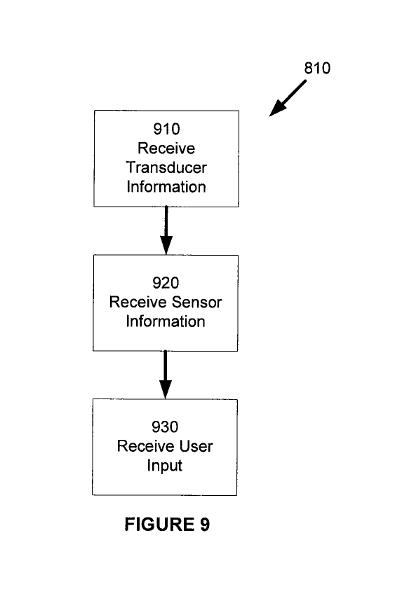

In act 810, an RF tag receives context information. FIG. 9 shows one embodiment of receiving context information.

In FIG. 9, the RF tag receives transducer information using a transducer [act 910]. As used herein, “receiving” may include identifying, reading, obtaining, collecting, retrieving, or requesting. The transducer information may be information received via the transducer. The transducer is operable to receive information that may be converted into an electrical signal. The information to be converted and/or the electrical signal may be transducer information. In one example, the transducer receives an incoming RF signal from an RF device. The incoming RF signal is transducer information. In act 920, the RF tag receives sensor information using a sensor. The sensor information is information received via the sensor. The sensor is operable to receive information that defines a system attribute. In one example, the sensor measures a container pressure. The container pressure is sensor information. In act 930, the RF tag receives user input information. The user input information is information provided by a user.

In FIG. 8, the RF tag determines communication characteristics for one or more RF devices in act 820. As used herein, determining may include signal processing, reading, associating, calculating, or approximating. In act 830, the RF tag is configured to communicate using communication characteristics. Configuring the RF tag may include configuring hardware, software, or the combination thereof. The RF tag may be configured to communicate using an efficient setting. In act 840, the RF tag communicates with an RF reader using the communication characteristics. Communication may include transmitting, receiving, or the combination thereof. For example, the RF tag may transmit sensor information to the RF reader using the communication characteristics.

In one embodiment, as shown in FIG. 8, the RF tag authenticates one or more of the acts or components in act 850. The authentication may take place at any stage of the method shown in FIG. 8. The authentication may authenticate communication transmitted to or being transmitted by the RF tag. For example, authentication may include validating everything that “touches” or communicates with the RF tag. For example, the

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for configuring a radio frequency (RF) tag, the method comprising:
determining communication characteristics for a first RF device coupled with the RF tag, the first RF device being operable to communicate with the RF tag using the communication characteristics, which define a first operating frequency, a first protocol, and a first waveform; and
configuring the RF tag as a function of the communication characteristics for the first RF device, such that the RF tag is operable to communicate with the first RF device at the first operating frequency and using the first protocol.

2. The method of claim 1, wherein configuring the RF tag comprises configuring hardware and software.

3. The method of claim 1, further comprising:
determining communication characteristics for a second RF device coupled with the RF tag, where the communication characteristics for the second RF device are used to communicate with the RF tag and define a second operating frequency, a second protocol, and a second waveform; and
configuring the RF tag as a function of the communication characteristics for the second RF device, such that the RF tag is operable to communicate with the second RF device at the second operating frequency and using the second protocol.

4. The method of claim 3,
wherein the first protocol is different than the second protocol; and
wherein the first waveform is different than the second waveform.

5. The method of claim 1, wherein determining the communication characteristics of the first RF device comprises using context information to determine the communication characteristics of the first RF device.

6. The method of claim 1, further comprising:
sensing an attribute related to the RF tag using a sensor; and
communicating the attribute from the RF tag to the first RF device using the communication characteristics for the first RF device.

7. The method of claim 1, wherein the attribute is an environment attribute related to the environment in which the RF tag is disposed.

8. The method of claim 1, wherein determining the communication characteristics includes authorizing the determination of the communication characteristics, and configuring the RF tag includes authorizing the configuration.

9. An RF Tag comprising:
a memory and a processor coupled with the memory, the memory comprising:
sensing instructions executable by the processor to cause the RF Tag to sense an attribute related to the RF tag,
determine instructions executable by the processor to cause the RF Tag to determine first RF device communication characteristics, which are used to communicate with a first RF device,
configure instructions executable by the processor to cause the RF Tag to configure the RF tag such that the RF tag is operable to communicate with the first RF device using the first RF device communication characteristics, and
communicate instructions executable by the processor to cause the RF Tag to communicate the attribute to the RF device using the first RF device communication characteristics.

10. The RF tag of claim 9, wherein the configure instructions are executable by the processor to cause the RF Tag to configure hardware and software.

11. The RF tag of claim 9, wherein the first RF device communication characteristics comprises an operating frequency and a first protocol, and wherein the first RF device is operable to operate at the operating frequency and communicate using the first protocol.

12. The RF tag of claim 9, wherein the memory comprises: reconfigure instructions executable by the processor to cause the RF Tag to reconfigure the RF tag such that the RF tag is operable to communicate with a second RF device using second RF device communication characteristics.

13. The RF tag of claim 9, wherein the memory comprises: receive instructions executable by the processor to cause the RF Tag to receive an incoming RF signal from the first RF device, and wherein the determine instructions are executed to determine the first RF device communication characteristics as a function of the incoming RF signal.

14. The RF tag of claim 9, wherein the memory comprises: authorize instructions executable by the processor to cause the RF Tag to authorize the RF reader prior to configuring the RF tag.

15. A system for communicating comprising:
a moveable object characterized by moveable object data; and
a configurable RF tag coupled with the moveable object, the configurable RF tag being operable to determine communication characteristics for a first RF device and configure RF tag components, which are coupled with the configurable RF tag, such that the configurable RF tag is operable to communicate with the first RF device using the communication characteristics for the first RF device,
wherein the RF tag is operable to communicate at least a portion of the moveable object data to the first RF device.

16. The system as claimed in claim 15, wherein the RF tag is operable to determine communication characteristics for a second RF device.

17. The system as claimed in claim 16, wherein the RF tag is operable switch from a configuration to communicate using the communication characteristics for the first RF device to a configuration to communicate using the communication characteristics for the second RF device.

18. The system as claimed in claim 15, wherein communication characteristics for the first RF device comprise a first frequency and a first protocol, and the communication characteristics for the second RF device comprise a second frequency and a second protocol.

19. The system as claimed in claim 15, wherein RF tag is operable to authorize configuration of the RF tag components.

20. The system as claimed in claim 15, wherein the RF device is operable to communicate the moveable object data to a user device.
